(19) United States
(12) Patent Application Publication
(10) Pub. No.: US 2014/0316601 A1
(43) Pub. Date: Oct. 23, 2014

(54) METHOD FOR PROVIDING CONTROL POWER WITH AN ENERGY STORE USING TOLERANCES AT THE TIME OF PROVIDING THE CONTROL POWER

(71) Applicants: Georg Markowz, Alzenau (DE); Wolfgang Schweissthal, Mandelbachtal (DE); Carsten Kolligs, Bottrop (DE); Holger Brezski, Fernwald (DE); Wolfgang Deis, Heidelberg (DE); Michael Igel, Saarbruecken (DE); Anna Flemming, Frankfurt (DE); Dennis Gamrad, Voerde (DE); Sebastien Cochet, Oberhausen (DE); Stefan Winternheimer, Saarbruecken (DE)

(72) Inventors: Georg Markowz, Alzenau (DE); Wolfgang Schweissthal, Mandelbachtal (DE); Carsten Kolligs, Bottrop (DE); Holger Brezski, Fernwald (DE); Wolfgang Deis, Heidelberg (DE); Michael Igel, Saarbruecken (DE); Anna Flemming, Frankfurt (DE); Dennis Gamrad, Voerde (DE); Sebastien Cochet, Oberhausen (DE); Stefan Winternheimer, Saarbruecken (DE)

(73) Assignees: Evonik Industries AG, Essen (DE); Evonik Degussa GmbH, Essen (DE); STEAG Power Saar GmbH, Saarbruecken (DE)

(21) Appl. No.: 14/357,289

(22) PCT Filed: Oct. 29, 2012
(86) PCT No.: PCT/EP12/71338

§ 371 Date: May 9, 2014

(30) Foreign Application Priority Data
Nov. 10, 2011 (DE) 10 2011 055 228.6

(51) Int. Cl. G05F 1/66

(52) U.S. Cl. CPC G05F 1/66
USPC 700/297

(57) ABSTRACT

A method for providing control power for an electricity network in which at least one energy store connected to the electricity network supplies energy to the electricity network as required and/or takes up energy from the electricity network as required, such that, when there is a change of required control power, a time after a change from which a changed control power is provided by the energy store is chosen in dependence on a charging state at a given time of the energy store. A device for carrying out such a method includes at least one energy store and a control system for controlling power of the energy store in an open-loop and/or closed-loop manner, the energy store being connected to an electricity network such that energy can be fed into the electricity network and can be removed from the electricity network by the device.

The invention relates to a method for providing control power for an electricity network in which at least one energy store connected to the electricity network supplies energy to the electricity network as required and/or takes up energy from the electricity network as required; and to a device for carrying out such a method.

Electricity networks are used to distribute electricity from usually a number of energy generators in large areas to many users and to supply households and industry with energy. Energy generators, usually in the form of power plants, provide the energy required for this. Electricity generation is generally planned and provided to meet the forecast consumption.

Both when generating and when consuming energy, it is possible however for unplanned fluctuations to occur. These may arise on the energy generator side for example as a result of a power plant or part of the electricity network failing or, for example in the case of renewable energy sources such as wind, the energy generation being greater than forecast. It is also possible with respect to the consuming entities for unexpectedly high or low levels of consumption to occur. The failure of part of the electricity network, for example cutting off some consuming entities from the energy supply, may lead to a sudden reduction in the electricity consumption.

This generally leads to fluctuations in the network frequency in electricity networks due to unplanned and/or short-term deviations of the power generation and/or consumption. In Europe, for example, the desired AC frequency is 50 000 Hz. This frequency is often also referred to as the desired frequency. A reduction in consumption from the planned level leads to an increase in the frequency of power generated as planned by the energy generators; the same applies to an increase in the electricity production as compared with the planned level when consumption is as planned. On the other hand a reduction in the power produced by the energy generators leads to a reduction in the network frequency when consumption is as planned; the same applies to an increase in consumption as compared with the planned level when generation is as planned.

For reasons of network stability, it is necessary to keep these deviations within defined boundaries. For this purpose, depending on the degree and direction of the deviation, positive control power must be specifically provided by connecting additional generators or disconnecting consuming entities or negative control power must be specifically provided by disconnecting generators or connecting consuming entities. There is a general need for cost-effective and efficient provision of these supplies of control power, it being possible for the requirements for the capacities to be maintained and the dynamics of the control power sources or sinks to vary according to the characteristics of the electricity network.

In Europe, for example, there is a code of practice (UCTE Handbook), which describes three different categories of control power. In it, the respective requirements for the types of control power are defined. Among the ways in which the types of control power differ are the requirements for the dynamics and the time for which power is to be delivered. They are also used differently with regard to the boundary conditions. Primary control power (‘PCP’) is to be delivered Europe-wide by all of the sources involved independently of the place of origin of the disturbance, this being substantially in proportion to the frequency deviation at the given time. The absolute maximum power has to be delivered when there are frequency deviations of minus 200 MHz and below (in absolute terms), the absolute minimum power has to be delivered when there are frequency deviations of plus 200 MHz and above. With regard to the dynamics, it is required that, from the non-operative state, the respective maximum power (in terms of the absolute amount) must be provided within 30 seconds. By contrast, secondary control power (SCP) and minutes reserve power (MR) are to be delivered in the balancing periods in which the disturbance has occurred. Their task is to compensate as quickly as possible for the disturbance and ensure that the network frequency is restored as quickly as possible to the desired range, preferably at the latest after 15 minutes. With regard to the dynamics, lower requirements are stipulated for the SCP and MRP (5 minutes and 15 minutes, respectively, before full power is delivered after activation); at the same time, these power outputs must also be provided over longer time periods than primary control power.

In the electricity networks operated until now, a large part of the control power has been provided by conventional power plants, in particular coal-fired and nuclear power plants. This results in two fundamental problems. On the one hand, the conventional power plants providing control power are not operated at full load, and consequently maximum levels of efficiency, but slightly below, in order to be able when required to provide positive control power, possibly over a theoretically unlimited time period. On the other hand, with increasing expansion and increasingly preferred use of renewable energy sources, there are fewer and fewer conventional power plants in operation, which however is often the basic prerequisite for delivering supplies of control power.

For this reason, there are plans under development for increasing use of energy stores to store negative control power and, when required, provide it as positive control power.

The use of hydraulic pumped storage plants for delivering control power is state of the art. In Europe, the various types of control power are delivered by pumped storage plants. Hydraulic pumped storage plants are however also repeatedly cited as currently the most cost-effective technology for storing and retrieving forms of renewable energy, to allow energy supply and demand to be better adapted to one another in terms of time. The potential for the expansion of storage capacities is a controversial subject of discussion—in particular in Norway—since use requires considerable capacities in power lines to be approved and installed. Consequently, use for energy load management is in competition with the provision of control power.

Against this background, in the area of primary control power many plans for also using other storage technologies, such as for example flywheel mass and battery stores, for the provision of control power have recently been investigated and described.

US 2006/122738 A1 discloses an energy management system which comprises an energy generator and an energy store, the energy store being able to be charged by the energy generator. This is intended to enable an energy generator that does not ensure uniform energy generation in normal operation, such as for example the increasingly favoured renewable energy sources such as wind-power or photovoltaic power plants, to deliver their energy more uniformly into the electricity network. A disadvantage of this is that, although a single power plant can be stabilized in this way, all other disturbances and fluctuations of the electricity network cannot be counterbalanced, or only to a very limited extent.

It is known from WO 2010 042 190 A2 and JP 2008 178 215 A to use energy stores for providing positive and negative control power. If the network frequency leaves a range around the desired network frequency, either energy is provided from the energy store or energy is taken up in the energy store, in order to control the network frequency. DE 10 2008 046 747 A1 also proposes operating an energy store in an island electricity network in such a way that the energy store is used to compensate for consumption peaks and consumption dips. A disadvantage of this is that the energy stores do not have the necessary capacity to compensate for a lengthy disturbance or a number of successive disturbances in the same direction with regard to the frequency deviation.

In the article “Optimizing a Battery Energy Storage System for Primary Frequency Control” by Oudalov et al., in IEEE Transactions on Power Systems, Vol. 22, No. 3 August 2007, the capacity of a rechargeable battery is determined in dependence on technical and operational boundary conditions, in order that it can provide primary control power in accordance with the European standards (UCTE Handbook). It has been found that, on account of storage and retrieval losses, in the long term repeated charging of the energy store at relatively great time intervals is unavoidable. Nevertheless, in the short term or temporarily, it may happen that the energy store is overloaded. In the article, a (limited) use of resistors is proposed. However, this leads to energy being destroyed, and generally a depreciation of the energy. In spite of this measure, with a full-load running time of 1.6 hours, the energy store is still of a comparatively large size, at least much larger than to conform to the minimum requirements of the UCTE Handbook. The comparatively high capacities entail corresponding investment costs and often make the use of stores uneconomical.

The price for the provision of control power is crucially based on how quickly the control power can be provided after a request, that is to say after a frequency deviation outside the tolerance. In the case of PCP and SCP, payment is made just for keeping the energy available on standby. In the case of SCP and MR, the operational price is also paid.

In the area of secondary control power provision, the various requirements for the dynamics of the delivery of power (commissioning and decommissioning) of the sources (or of the pools of sources) are explained below for the example of the European interconnected network of the UCTE.

1. The prequalifiable secondary control power (SC power, SCP or else nominal power for short) results from the change in power (any direction of control) that is activated and measured within 5 minutes.

2. Brief overshooting of a maximum of 10% above the secondary control power setpoint value is admissible. In any event, brief overshooting of up to 5 MW is admissible.

3. In the case of secondary control power pools, a reaction of the pool must be measurable for the transmission network operator after 30 seconds at the latest.

The payments for the provision of secondary control power are made up of a system charge for keeping the secondary control power on standby and a supply charge for the energy actually delivered in the course of the provision of secondary control power.

Such provisions, in particular concerning groups of energy generators, can be seen in the forum of network technology/network operation of the VDE (FNN) “TransmissionCode 2007”, of November 2009. Relevant in this respect in particular is Appendix D2 for the requirements of SCP pools, in which it is also described by which methods a master control technique can be operated by a supplier of SCP.

When using power plants or consuming entities, such as electrolysis works, for the provision of control power, there is the problem that they cannot be run up quickly enough to provide for MR or for SCP in case of need at the speed required.

Rechargeable batteries and other energy stores can take up or deliver energy very quickly, as a result of which they are in principle suitable for providing PCP. However, a disadvantage of this is that very large capacities of the rechargeable batteries have to be provided in order also to be able to supply the power over a lengthy time period or repeatedly. However, rechargeable batteries with a very great capacity are also very expensive.

On account of the losses during storage and retrieval of energy, a draining of the energy store, such as for example a rechargeable battery, takes place sooner or later when there is a statistically symmetric deviation of the network frequencies from the setpoint value through operation. It is therefore necessary to specifically charge the energy store more or less regularly. This charging current must possibly be paid for separately.

U.S. Pat. No. 7,839,027 B2 discloses a method of the generic type for providing control power by an energy store. In this method, the energy store is charged or discharged in the times in which no control power is required in order to achieve a desired initial state of charge. A disadvantage of this is that the power must be drawn from the network, that is to say must be paid for. It is also disadvantageous that, if many control cycles follow one another, the energy store is still always strongly charged or discharged. Therefore, a large capacity (energy storage capacity) of the energy store must still always be provided.

Consistent adherence to the guidelines for the prequalification of primary control technologies requires the provision of corresponding power reserves at every desired operating time, and consequently every desired charging state of the energy store. This requirement (in Germany at present: the marketed primary control power over a period of 15 minutes) has the effect that a corresponding capacity has to be provided, resulting in increased investment costs. In fact, such a reserve would (on a statistical basis) only be used very rarely.

It has been found in the course of developing the invention that sometimes considerable amounts of energy are fed in or out monotonously, as shown by an analysis of actual variations in frequency conducted by the inventors. With a given storage capacity, this leads to a correspondingly great change in the charging state. Great changes in charging state in turn tend to lead to faster aging than small changes in charging state. Consequently, either the energy store reaches the end of its lifetime and must be exchanged earlier, or the capacity has to be increased a priori in order to reduce the relative change in charging state. Both lead to an increase in investment costs.

The object of the invention is therefore to overcome the disadvantages of the prior art. In light of the prior art, it is thus particularly the object of the present invention to provide a technically improved method for providing control power for an electricity network in which at least one energy store connected to the electricity network supplies energy to the electricity network as required and/or draws energy from the electricity network as required that is not affected by the disadvantages of conventional methods. It is also intended to find a possible way of improving the cost-effectiveness of the operation of energy stores, such as rechargeable batteries, for the provision of primary control power by avoiding inefficient charging states. It is intended at the same time as far as possible to make the provision of primary control power possible with lower energy storage capacity. Moreover, it would also be advantageous if less loading with an aging effect could be achieved. Furthermore, the provision of primary control power while avoiding intermediate charging would also be desirable. It is also intended for control power to be provided with an efficient energy yield of the control power supplier.

It can be seen as a further object of the invention that, in particular when using galvanic elements, such as rechargeable batteries, the capacity of the energy store for providing the required control power is intended to be as small as possible.

Furthermore, it should be possible for the method to be carried out as easily and inexpensively as possible.

In addition, it should be possible for the method to be carried out with fewest possible method steps, while these steps should be simple and reproducible.

Further, not explicitly mentioned objects emerge from the overall context of the following description, examples and claims.

These objects and further objects, which are not explicitly mentioned but readily emerge or are readily foreseeable from the contexts discussed in the introduction hereof, are achieved by a method having all the features of Patent Claim 1. Expedient modifications of the method according to the invention for providing control power for an electricity network in which at least one energy store connected to the electricity network supplies energy to the electricity network as required and/or takes up energy from the electricity network as required are afforded protection in dependent Claims 2 to 16. Furthermore, the subject matter of Patent Claim 17 is a device for carrying out such a method, while expedient modifications of this device are afforded protection in dependent Claims 18 to 20.

The present invention is accordingly realized by a method for providing control power for an electricity network in which at least one energy store connected to the electricity network supplies energy to the electricity network as required and/or takes up energy from the electricity network as required and is characterized in that, when there is a change of the required control power, the time after the change from which a changed control power is provided by the energy store is chosen in dependence on the charging state at the given time of the energy store.

Moreover, inter alia, the following advantages can be obtained by the method according to the invention:

This successfully realizes in an unforeseeable way a method for providing control power for an electricity network in which at least one energy store connected to the electricity network supplies energy to the electricity network as required and/or takes up energy from the electricity network as required that is not affected by the disadvantages of conventional methods.

Furthermore, the cost-effectiveness of the operation of energy stores, such as rechargeable batteries, for the provision of primary control power is improved by the method according to the invention by avoiding inefficient charging states, provision of primary control power with a lower energy storage capacity being made possible in particular.

Less loading with an aging effect is achieved by the method according to the invention, while also avoiding intermediate charging for the provision of primary control power.

Furthermore, the required control power is provided with an efficient energy yield of the control power supplier.

Systems with a greatly limited storage size come into consideration in particular as energy stores. In English-speaking countries, these are sometimes referred to as Limited Energy Storage Resources (LESRs).

In particular when using galvanic elements, such as rechargeable batteries, the capacity of the energy store for providing the required control power can be kept low on account of the possibility of quickly changing the control power of the energy store.

In addition, the method according to the invention can be carried out very easily and inexpensively.

Furthermore, the method can be carried out with relatively few method steps, while these steps are simple and reproducible.

It may be provided according to the invention that the time lies in a time interval between the change of the required control power and a maximum time after the change, the time interval preferably depending on the type of control power requested, in particular the time interval being 30 seconds in the case of provision of primary control power, 5 minutes in the case of provision of secondary control power and 15 minutes in the case of provision of minutes reserve power.

As a result, the use of an energy store can be further optimized in dependence on the type of control power demanded, in order when there is sufficient capacity of the energy store to provide the control power requested by the network operators as soon as possible, preferably before the elapse of the maximum admissible time interval, that is to say within an allowed time tolerance for achieving setpoint values of the control power.

It may also be provided that the charging state of the energy store is adapted by choosing the time, in particular a desired medium energy content in the energy store is aimed for, the desired medium energy content lying in the range between 20% and 80% of the maximum energy content in the energy store, preferably lying between 40% and 60%, particular preferably at 50% of the maximum energy content in the energy store.

By aiming in this way for a medium desired charging state or the medium desired energy content of the energy store, the use of such an energy store can be used in a surprisingly advantageous way for the provision of control power for an electricity network, without for example energy stores with greater capacities becoming necessary. In this way, the disadvantages of classical energy generators and energy consuming entities, which have to be operated at least in part load for the provision of control power, can be avoided. The great moment of inertia of such power plants with respect to the running up and running down to control power generates enormous additional costs, and is to this extent disadvantageous. In the case of rechargeable batteries as the energy store, the charging state corresponds to the state of charge (SOC) or the energy content (state of energy, SoE).

In a preferred embodiment of the method according to the invention it may be provided that, when there is a change of the required control power, positive control power is fed into the electricity network at an early time, preferably immediately, and/or negative control power is removed from the electricity network at a late time, preferably at the latest possible time, if the charging state of the energy store lies above a first limit value and/or, when there is a change of the required control power, negative control power is removed from the electricity network at an early time, preferably immediately, and/or positive control power is fed into the electricity network at a late time, preferably at the latest possible time, if the charging state of the energy store lies below a second limit value, the two limit values particularly preferably defining a desired medium charging state.

The coupling of the dynamic provision of control power by the energy store in dependence on its charging state makes it possible in an advantageous way to react to control power requests, it being intended to use the capacity of the energy store in such a way that it is as far as possible in the medium charging state, in order in this way to ensure the most efficient and cost-conscious handling.

In a further embodiment of the method according to the invention, the energy store is operated jointly with at least one energy generator and/or at least one energy consuming entity for the provision of control power for the electricity network.

It may be provided in particular here that the energy store is operated in its closed-loop control and/or open-loop control in dependence on and in operative connection with the at least one energy generator and/or with the at least one energy consuming entity in the provision of control power for an electricity network.

A power plant, preferably a coal-fired power plant, a gas-fired power plant or a hydroelectric power plant, may be used as the energy generator, while a works for producing a substance, in particular an electrolysis works, or a metal works, preferably an aluminium works or steelworks, may be used as the energy consuming entity.

Such energy generators and energy consuming entities are well suited for the provision of supplies of control power in the relatively long term. According to the invention, their inertia can be balanced out well by energy stores.

It may also be provided that at least 95% of the maximum power that can be delivered to the electricity network, in particular the nominal power of the energy generator together with the energy store, and/or at least 95% of the maximum power that can be taken up from the electricity network, in particular the nominal power of the energy consuming entity together with the energy store, is provided by the method within 15 minutes, preferably within 5 minutes, particularly preferably within 30 seconds.

It may also be provided that the energy generator and/or the energy consuming entity has or have a maximum power output of at least 1 MW, preferably at least 10 MW, particularly preferably at least 100 MW.

It may also be provided that a flywheel, a heat store, a hydrogen generator and store with a fuel cell, a natural gas generator with a gas-fired power plant, a pumped storage power plant, a compressed-air storage power plant, a superconducting magnetic energy store, a redox-flow element and/or a galvanic element, preferably a rechargeable battery and/or a battery storage power plant, is used as the energy store. The heat store must be operated together with a device for producing electricity from the stored thermal energy.

The rechargeable batteries include, in particular, lead batteries, sodium-nickel chloride batteries, sodium-sulphur batteries, nickel-iron batteries, nickel-cadmium batteries, nickel-metal hydride batteries, nickel-hydrogen batteries, nickel-zinc batteries, tin-sulphur-lithium-ion batteries, sodium-ion batteries and potassium-ion batteries.

Of these, rechargeable batteries that have a high efficiency and a high operational and calendar lifetime are preferred. Accordingly, among the preferred rechargeable batteries are in particular lithium-ion batteries (for example lithium-polymer batteries, lithium-titanate batteries, lithium-manganese batteries, lithium-iron-phosphate batteries, lithium-iron-manganese-phosphate batteries, lithium-iron-yttrium-phosphate batteries) and also further developments of these, such as for example lithium-air batteries, lithium-sulphur batteries and tin-sulphur-lithium-ion batteries.

Rechargeable batteries in particular are particularly suitable for methods according to the invention, on account of their rapid reaction time, that is to say the rate at which the power can be increased or reduced. Moreover, the efficiency, in particular in the case of Li-ion batteries, is good in comparison with many other energy stores.

It may also be provided that the energy store has a capacity of at least 1 kWh, preferably at least 10 kWh, particularly preferably at least 50 kWh, most particularly preferably at least 250 kWh.

The capacity of electrochemical energy stores may in this case be at least 40 Ah, preferably approximately 100 Ah. The individual cells of electrochemical energy stores may operate at at least 1 V, preferably at at least 10 V, particularly preferably at at least 100 V.

These capacities are still relatively low for the operation of a control power power plant or a control power consuming entity. The great capacity in comparison with commercially available small energy stores, such as for example rechargeable batteries of a mobile phone, and the great energy storing ability are suitable for allowing the considerable amounts of energy for the methods according to the invention to be provided, even in the case of large electricity networks.

It may also be provided that a change of the required control power is established by a change of the frequency deviation of the network frequency of the electricity network from the setpoint value of the network frequency of the electricity network being measured, in particular a change of the frequency deviation by a minimum amount, preferably by 10 MHz, the amount of the control power preferably depending on the level of the frequency deviation, particularly preferably being chosen in certain regions in linear proportion to the level of the frequency deviation.

In the case of direct determination of the network frequency or the frequency deviation, own measuring apparatuses can be used. This provides the possibility of determining the frequency deviation with a greater accuracy than is prescribed by the network operator. As a result, a greater frequency tolerance can be used to control the charging state of the energy store.

It may be particularly preferred here that the frequency deviation is measured with a greater accuracy than is necessary for delivering the control power, preferably with an accuracy of at least ±8 MHz, particularly preferably of at least ±4 MHz, most particularly preferably of at least ±2 MHz, especially preferably of at least ±1 MHz.

The greater the accuracy can be carried out when determining the frequency deviation of the network frequency from the setpoint value, the greater the latitude that can be used to adapt the charging state of the energy store.

It may also be provided that a tolerance with respect to the frequency deviation from the setpoint value of the network frequency of the electricity network is used in order to set the charging state of the energy store at the same time as providing the control power by the energy store.

It may also be provided that the tolerance with respect to the amount of the control power provided is used in order to set the charging state of the energy store at the same time as providing the control power by the energy store, preferably the amount of the requested control power being exceeded, in particular by a maximum of 30% and/or by 10 MW, particularly preferably by a maximum of 20% and/or by 5 MW, to make use of the tolerance with respect to the amount of the control power provided, the percentage by which the amount of the requested control power is exceeded being chosen particularly preferably in proportion to the deviation of the charging state of the energy store from a desired medium charging state.

The tolerance with respect to the amount of the control power provided and the tolerance in the determination of the frequency deviation should be understood according to the invention as meaning that, on account of technical boundary conditions, such as the measuring accuracy when determining the control power delivered or the network frequency, certain deviations between an ideal desired power and the control power actually delivered are accepted by the network operator.

The tolerance may be granted by the network operator, but could also correspond to a legal provision.

The advantage of this procedure can be seen as being that it succeeds in controlling the charging state (state of charge) of the energy store or the amount of energy contained in the energy store also during the delivery of the control power, and consequently also continuously. The terms state of charge and charging state are to be regarded according to the invention as equivalent.

In the case of rechargeable batteries as the energy store, the charging state corresponds to the state of charge (SOC) or the energy content (state of energy, SoE). According to the invention, the charging state may be determined by measuring the state of charge (SOC) or the energy content of the energy store.

It may be advantageously provided here that the charging state of the energy store is set by the energy store feeding into the electricity network a greater control power, lying within the tolerance or the tolerances, or taking up from the electricity network a smaller control power, lying within the tolerance or the tolerances, in the case where the charging state of the energy store lies above a first limit value, and/or the energy store feeding into the electricity network a smaller control power, lying within the tolerance or the tolerances, or taking up from the electricity network a greater control power, lying within the tolerance or the tolerances, in the case where the charging state of the energy store lies below a second limit value.

This provides details of how control of the charging state according to the invention can be achieved. These principles reflect generally applicable reference points of a method according to the invention that achieves the objects on which the invention is based.

It may be provided that the first limit value of the charging state lies between 40% and 80% of the maximum charge of the energy store, preferably between 45% and 70%, particularly preferably between 50% and 60%, and/or the second limit value of the charging state lies between 20% and 60% of the maximum charge, preferably between 30% and 55%, particularly preferably between 40% and 50%, or the first and second limit values of the charging state lie at 50% of the maximum charge of the energy store.

The stated ranges for the limit values of the charging state of the energy store are particularly suitable according to the invention for realizing methods according to the invention. In particular in the case of a great capacity of the energy store, the limit values may also lie at 80% and 20%, respectively, of the maximum charge of the energy store.

It may also be provided that the first and/or the second limit value of the charging state can be chosen in dependence on whether positive or negative control power is required, and so, when there is a requirement for positive control power, the first limit value and/or the second limit value of the charging state is chosen for a greater charge of the energy store and, when there is a requirement for negative control power, the first limit value and/or the second limit value of the charging state is chosen for a smaller charge of the energy store, the limit values preferably being chosen as a function of the frequency deviation of the network frequency.

These measures allow the charging state of the energy store to be adapted even better.

A particularly preferred embodiment of a method according to the invention is obtained if it is provided that a control power gradient is chosen in dependence on the charging state of the energy store, the variation over time of the amount of the control power being particularly set and the tolerance of the amount of the control power to be provided over time being used.

This makes use of the fact that there are tolerances with respect to the rise or fall of the control power to be provided, given for example by the network operator or by legal provisions. These tolerances may be used according to the invention to adapt the charging state of the energy store. This provides a further improvement in the optimization of the charging state, or this embodiment represents a particularly preferred realization of the method according to the invention. As a result, the size, or the capacity, of the energy store can be reduced further.

It may also be provided particularly preferably that, when there is a change of the frequency deviation by less than a range of insensitivity, in particular by less than 10 MHz, a changed control power can only be delivered to set the charging state of the energy store, in particular the changed control power can only be delivered if the charging state of the energy store is thereby moved as strongly as possible towards the medium charging state or as little as possible away from the medium charging state.

The change of the frequency deviation relates here to that frequency deviation at which the last control power adaptation took place. This makes use of a further tolerance. This tolerance may be given by the network operator or the legislature or be inherent within the system. The tolerance allows that no adaptation of the control power has to take place when only small changes of the frequency deviation of the network frequency from the desired frequency occur. In order to develop the charging state of the energy store in the desired direction, control power may nevertheless be delivered. This delivery of control power possibly takes place in the way desired, that is to say for example directly in inverse proportion to the frequency deviation. If therefore control power is delivered to adapt the charging state, this would contribute to controlling the network frequency. The adaptation of the charging state therefore always takes place constructively in the sense of controlling the network frequency. A precondition for this is that the frequency deviation can be measured with greater accuracy than the range of insensitivity. The range of insensitivity is a measure of the tolerance of the change of the frequency deviation from which a change of the control power is required or necessary.

The object of the invention is achieved with respect to a device by the device comprising at least one energy store and a control system for controlling the power of the energy store in an open-loop and/or closed-loop manner, the energy store being connected to an electricity network in such a way that energy can be fed into the electricity network and can be removed from the electricity network by the device.

In the present case, a control system is understood according to the invention as meaning a simple control system. It should be noted here that any closed-loop control comprises an open-loop control, since in closed-loop control an open-loop control takes place in dependence on a difference between an actual value and a setpoint value. The control system is therefore preferably formed as a closed-loop control system, in particular with respect to the charging state. Particularly preferably, the control system is a master control system.

It may in this case be provided that the device comprises at least one energy generator and/or at least one energy consuming entity that is connected to the electricity network in such a way that control power can be fed into the electricity network by the energy generator and/or can be removed from the electricity network by the energy consuming entity and the energy store can preferably be charged by the energy generator and/or discharged by the energy consuming entity.

It may also be provided that the device comprises a device for measuring the charging state of the at least one energy store and a data memory, the desired medium charging state of the energy store being stored in the data memory, the control system having access to the data memory and being designed for controlling the control power delivered and/or taken up by the energy store in dependence on the charging state of the energy store.

Finally, it may also be provided that the energy store is a rechargeable battery, preferably a lithium-ion battery, a lead-sulphuric acid battery, a nickel-cadmium battery, a sodium-sulphide battery and/or a Li-ion battery and/or a composite of at least two of these rechargeable batteries.

The invention is based on the surprising finding that energy stores can be operated in such a way that the tolerances given by the network operators are used when delivering control power for keeping the charging state of the energy store in a medium range, and thus keeping the capacity of the energy store within low-cost boundaries. This applies in particular to energy stores that can take up and deliver energy quickly, that is to say with high power gradients, such as for example flywheels and, in particular, rechargeable batteries and battery stores. The reason for the tolerances allowed by the network operators is therefore that the control power is usually provided at present by relatively large power plants, such as for example coal-fired power plants, and relatively large consuming entities, such as for example electrolysis works. These control power suppliers have a great inertia in taking up and delivering control power, that is to say that their power gradients are small and effects such as overshooting within certain boundaries are unavoidable. Therefore, certain tolerances are allowed. Thus, for example, control power suppliers do not have to supply control power even when there are extremely small deviations, but instead a tolerance in the frequency deviation of the network frequency from which control power has to be made available is allowed. It can in this way be ensured that the provision of control power serves exclusively for stabilizing the network frequency. Furthermore, a tolerance is allowed in the measurement of the frequency deviation of the network frequency, so that the control power to be delivered can be chosen freely within certain boundaries (within a tolerance), as long as the frequency deviation can be measured more accurately.

The present invention makes use in particular of the fact that the time from which a changed control power has to be delivered after a change of the required control power, that is to say a change of the setpoint value of the control power, after the required control power has changed has a tolerance, which may depend on the type of control power to be delivered. The latter tolerance is used according to the invention to adapt the charging state of the energy store in that more or less energy is stored into the energy store or more or less energy is delivered from the energy store to the electricity network. In dependence on the charging state (that is to say as required), a slower-responding control power source is produced by the control system with the energy store, in order to adapt the charging state of the energy store.

A further tolerance is also obtained in the accuracy of what power can be fed into the electricity network or can be taken up from the electricity network. In this respect, it is usually not important to the network operator whether the control power required is delivered or whether it is exceeded by a certain amount or there is a slight shortfall.

These tolerances can be used to make available more or less control power, and thus charge or discharge the energy store specifically more strongly or less strongly. As a result, the charging state can be specifically influenced. The invention thus succeeds in keeping the charging state in a desired range, for example in a medium range, so that the energy store is in a good, or even optimum, initial state for the next or a changed control power request.

The charging state then no longer has to be controlled, or can be controlled with less energy from the electricity network. Moreover, the capacity of the energy store can be chosen to be smaller. Both save costs.

Among the ways in which battery stores (rechargeable batteries) are distinguished in comparison with conventional technologies for providing primary and/or secondary supplies of control power is that they can change the supplies of power delivered much more quickly. However, in most cases it is disadvantageous with battery stores that they have a comparatively small storage capacity, and therefore can only deliver the required supplies of power over a limited period of time. In a statistical evaluation of the frequency deviations over time, it has surprisingly been found in the course of developing the present invention that, in over 75% of the active time (that is to say power other than zero is delivered), the requested supplies of power amount to less than 10% of the maximum power or the marketed power.

It likewise follows from this finding according to the invention that the capacity of the energy store, and consequently the stored amount of control power to be kept available, can be chosen to be smaller, and keeping the capacity of the energy store small can be achieved particularly successfully by a method according to the invention.

The invention makes use of the fact that it is possible with modern measuring devices and measuring methods to determine the frequency deviation more accurately than is required at present for delivering control power. This makes it possible for the control power that is to be delivered to be chosen freely within the prescribed tolerances (that is to say within the prescribed limits) and, as a result, for the method to be realized.

Special and particularly preferred embodiments of the ways of achieving the objects are that the energy store is a rechargeable battery or a battery store that is used for delivering primary control power.

In a further special embodiment, the energy taken up into the energy store in the case of negative PC or SC power can be sold on the spot market, in particular when the conditions there are advantageous.

According to a further embodiment, it may be provided within the provisions for delivering control power that in particular more energy is taken up from the network by the energy store than is fed in. This may take place because, according to the regulations including the previously set out procedure, preferably a very large amount of negative control power is provided, whereas, according to the regulations including the previously set out procedure, preferably only the minimum assured amount of positive control power is delivered. Preferably, on average at least 0.1% more energy is taken from the network than is fed in, in particular at least 0.2%, preferably at least 0.5%, particularly preferably at least 1.0%, especially preferably 5%, these values being referred to an average that is measured over a time period of at least 15 minutes, preferably at least 4 hours, particularly preferably at least 24 hours and especially preferably at least 7 days, and relates to the energy fed in.

This may involve using the previously set out delivery of control power in order to take a maximum of energy from the network, the maximum possible negative control power being provided while only a minimum of positive control power is delivered.

In the embodiments of the preferred, and especially maximum, energy take-up, the supplies of energy thereby taken from the network can be sold through the previously described energy trade, this preferably taking place at times at which a price that is as high as possible can be achieved. Forecasts of the price development that are based on historical data may be used for this purpose.

Furthermore, the charging state of the energy store at the time of a planned sale of energy may be preferably at least 70%, particularly preferably at least 80% and particularly preferably at least 90% of the storage capacity, the charging state after the sale preferably being at most 80%, in particular at most 70% and particularly preferably at most 60% of the storage capacity.

In preferred embodiments of the invention, a number of energy stores are pooled and operated by a procedure according to the invention. The size of the energy stores within the pool may vary. In a particularly preferred embodiment, when using tolerances for the various energy stores of a pool, the change from one parameter setting to another is not performed synchronously but specifically at different times, in order to keep any disturbances in the network as small as possible or at least to a tolerable level.

In a further preferred embodiment, the tolerances used in the various procedures vary according to the time of day, the day of the week or the time of year. For example, in a time period of from 5 minutes before to 5 minutes after the change of hour, the tolerances are defined more narrowly. The reason for this is that often very rapid frequency changes take place here. It may be in the interests of the transmission network operators that there are smaller tolerances here, and consequently the provision of control energy takes place more dependably, in the sense of more strictly.

In the following text, exemplary embodiments of the invention are explained on the basis of three schematically depicted figures, without however restricting the invention in the process. In detail:

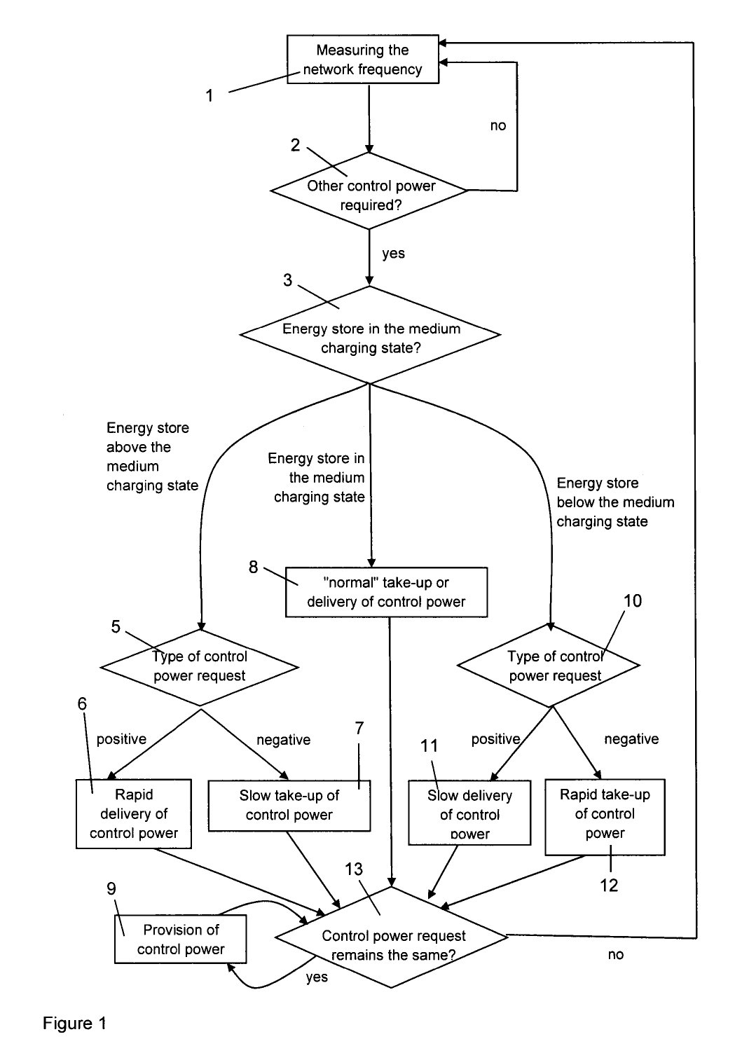

FIG. 1 shows a flow diagram for a method according to the invention;

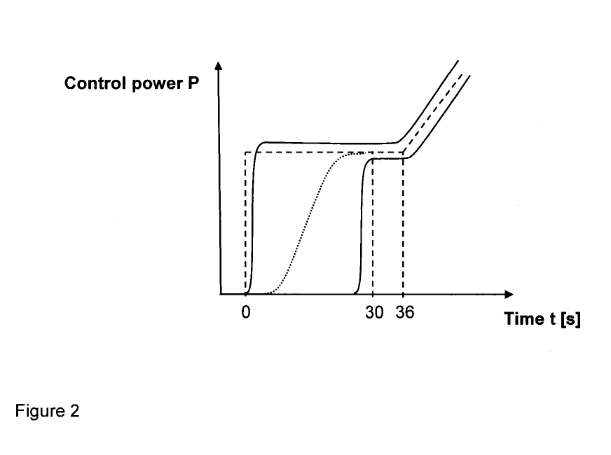

FIG. 2 shows a schematic control power/time diagram for a method according to the invention; and

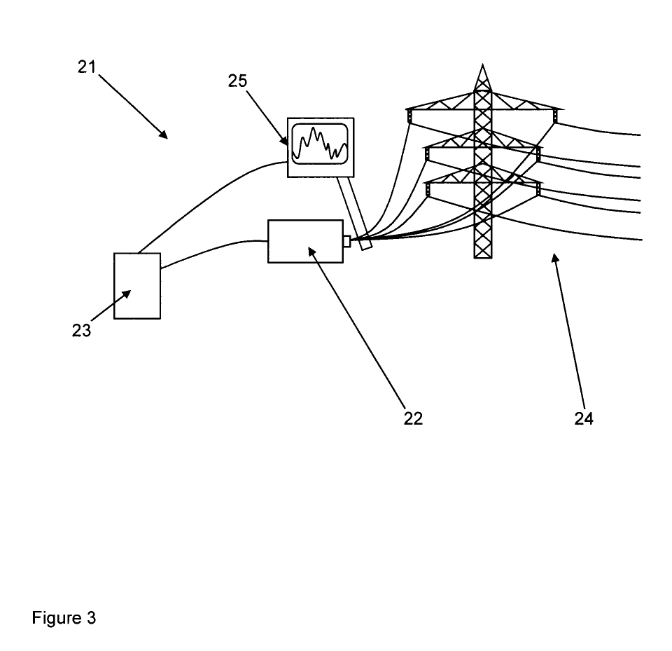

FIG. 3 shows a schematic representation of a device according to the invention for providing control power.

FIG. 1 shows a flow diagram for a method according to the invention. Here, the cycle begins with method step 1, in which the network frequency of an electricity network is measured. In decision step 2, it is checked whether a change of the control power is required. If there is therefore a changed request for control power from a network operator, or a need for control power is measured by measuring the frequency deviation from the setpoint value of the network frequency, first the charging state of an energy store is checked in a subsequent decision step 3, in order to establish whether or not the energy store is in the range of the desired medium charging state.

If this is the case, there is in a method step 8 a “normal” provision of control power by the energy store, a “normal” provision being referred to when there is no speeded-up and/or slowed-down delivery or take-up of control power by the energy store, but instead, in dependence on the type of control power requested, the energy store provides such a control power in the middle of the permissible time interval.

If, on the other hand, in decision step 3 it is established that the charging state of the energy store is above the medium charging state of the energy store, it is checked in a decision step 5 whether positive or negative control power is being demanded.

In the case of a need for positive control power when there is a charging state of the energy store above the medium charging state of the energy store, there is in a method step 6 a rapid delivery of control power from the energy store to the electricity network, so that the requested control power is fed into the electricity network at as early a time as possible, preferably immediately, after the time of the request for the control power.

In the case of a need for negative control power when there is a charging state of the energy store above the medium charging state of the energy store, there is in a method step 7 a slow take-up of control power from the electricity network into the energy store, this control power being removed from the electricity network at as late a time as possible, preferably at the latest possible time, after the time of the request for the control power.

If, on the other hand, in decision step 3 it is established that the charging state of the energy store is below the medium charging state of the energy store, it is checked in a decision step 10 whether positive or negative control power is being demanded.

In the case of a need for positive control power when there is a charging state of the energy store below the medium charging state of the energy store, there is in a method step 11 a slow delivery of control power from the energy store into the electricity network, this control power being fed into the electricity network at as late a time as possible, preferably at the latest possible time, after the time of the request for the control power.

In the case of a need for negative control power when there is a charging state of the energy store below the medium charging state of the energy store, there is in a method step 12 a rapid take-up of control power from the electricity network into the energy store, this control power being removed from the electricity network at as early a time as possible, preferably immediately, after the time of the request for the control power.

In a decision step 13, it is finally checked whether the request for control power by the network operator has remained the same, and consequently there is no changed need for control power. If this is the case, then in step 9 the control power is provided as before and it is also checked whether the request for control power has changed. If the need for control power changes, the process continues with method step 1. In method step 9 it may be provided that the charging state of the energy store is adapted by making use of tolerances in the delivery of power with respect to the power and with respect to a frequency deviation in order, according to the charging state of the energy store, to feed more or less control power into the network or take out more or less control power. For this purpose, within the boundaries of these tolerances, a slightly higher power and/or a slightly lower power than would correspond to the control power actually requested is always provided as control power.

FIG. 2 shows a schematic control power/time diagram on the basis of which a method according to the invention for providing control power by an energy store is to be explained. The dashed line shows by way of example a request for positive control power by a network operator, which is determined for example by measuring a frequency deviation from a setpoint value of the network frequency (in Europe 50 000 Hz).

At the time t=0 seconds, there is a request for positive power, that is to say a control power is to be made available to the electricity network. According to the invention, the control power can thus be delivered in dependence on how the charging state of the energy store with which the control power is delivered is. If the charging state is lower than desired, that is to say for example below a limit value, as little energy as possible should be additionally removed from the energy store. Provision of control power for this is represented by the right-hand lower curve. If the charging state is higher than desired, that is to say for example above a second or the same limit value, as much energy as possible should be additionally removed from the energy store. Provision of control power for this is represented by the left-hand upper curve. If the charging state lies in the medium standard range, a curve profile in the region between the two curves may be chosen, precisely the desired setpoint value of the control power always being delivered at least after 30 seconds. The 30 seconds (for PCP) is the time tolerance that the network operator allows for delivering the requested control power.

If the energy store is very fully charged, an amount of the positive control power that is slightly higher than desired, within the boundaries of the tolerance, is delivered and the amount is delivered as quickly as possible. The ramps shown, in particular of the dotted line (see below), serve for the adaptation of the charging state of the energy store.

However, it is possible within the provisions of the regulations for primary control power for the full power only to be delivered after 30 seconds. This tolerance is used if the charging state of the energy store is lower than desired. Then, the full control power is only delivered at the latest possible time, that is to say such that, in the case of PCP, the control power is only delivered 30 seconds after the request for control power. Alternatively, it may also be that the full control power is not delivered, but instead a somewhat lower power, if this is allowed by the tolerances for delivering power or the tolerances of the frequency deviation for determining the amount of the control power.

As from a time period 36 seconds after the request for control power, the control power must be increased on account of an ever increasing frequency deviation (shown here approximately linearly for simplification). This is again made dependent on the charging state of the energy store, the tolerances in the determination of the frequency deviation and/or in the provision of power being used for this.

The area between the two curves with the solid line corresponds to the energy difference that is obtained due to the different operating modes of the energy store, depending on whether it has been charged more than desired or less than desired and, accordingly, the energy store is to be discharged or charged. This energy difference may therefore be used to adapt the charging state of the energy store. According to the invention, the adaptation may take place during a request for control power and/or also while control power is being delivered.

In the case of a request for negative control power (energy must be taken up from the electricity network), such a discussion may be carried out on the basis of the same diagram, the right-hand lower curve being used when there is a charging state of the energy store that is charged above a third limit value and the left-hand upper curve being used when there is a charging state of the energy store that is charged below a fourth limit value.

The horizontal time axis does not necessarily have to intersect the axis of the control power at the zero point. A change of the necessary control power may also be based on an original control power that does not correspond to zero.

Drawn between the two curves with a solid line is a further possible curve with a dotted line for which the control power gradient has also been adapted in order to adapt the charging state of the energy store. Therefore, quite generally, and not only with respect to the present exemplary embodiment according to FIG. 2, the transfer behaviour of the energy store with an inertia of a relatively high order can be simulated by a method according to the invention. It is therefore possible not only to adapt the time of the delivery of control power but also the rise in control power and the shape of this curve, that is to say generally the control power gradient.

FIG. 3 shows in a schematic view a device 21 according to the invention, comprising an energy store 22. A control system 23 is connected to the energy store 22, so that the control system 23 can set the power take-up and delivery of the energy store 22.

The energy store 22 is connected to an electricity network 24 and can take up power from the electricity network 24 and/or deliver power. The control system 23 is connected to a device 25 for measuring the deviation between the network frequency at the given time and the setpoint value of the network frequency (in Europe 50 000 Hz) of the electricity network 24, in order to establish whether or not a control power must be delivered. If there is a need for control power—positive or negative control power—, the control system 23 generates a signal. Subsequently, the control power of the energy store 22 is changed, in particular is controlled in dependence on the signal generated. The device 25 is capable of determining the frequency deviation of the network frequency more accurately than is required. Thus, the tolerance in the determination of the network frequency can be used to set the charging state of the energy store 22.

The charging state of the energy store 22 can be determined by the control system 23 by way of a suitable measuring device, in order to implement a method according to the invention.

The control system 23 may in this case charge or discharge the energy store 22 in such a way as to aim for a certain desired charging state. The time tolerance that the network operator allows its control power suppliers is used here. Therefore, the requested power is delivered at an early time or at a later time. This energy difference is used here to adapt the charging state of the energy store 22.

Furthermore, tolerances in the frequency deviation from which a control power is to be delivered, and tolerances in the amount of the control power to be delivered when there is a certain frequency deviation, or tolerances in the determination of the frequency deviation as well as tolerances in the prequalified control power that can be delivered as a maximum are used to develop the charging state of the energy store 22 in the desired direction. Thus, for example, the power of the energy store 22 may already be provided in order to charge or discharge the energy store 22 when there is a smaller frequency deviation than a frequency deviation of 10 MHz, if this appears to be necessary. Similarly, an over-provision of up to 20% beyond the maximum control power may be produced by the energy store 22 in order to control the charging state of the energy store 22.

A particularly quickly reacting and easily chargeable and dischargeable energy store 22 is particularly advantageous in such cases in particular. Rechargeable batteries are best suited for this. Li-ion batteries in particular can be quickly and frequently charged and discharged without any harmful influences on the battery, and so these are particularly suitable and preferred according to the invention for all of the exemplary embodiments. For this, Li-ion batteries with a considerable capacity must be provided. These can for example be easily accommodated in one or more 40 foot ISO containers.

A device 21 according to the invention is therefore particularly well-suited as a primary control power source or else as a secondary control power source.

For details concerning the control of control power and concerning information exchange with the network operators, reference is made to the network technology/network operation forum in the VDE (FNN) “TransmissionCode 2007” of November 2009.

The features of the invention disclosed in the preceding description, and in the claims, figures and exemplary embodiments can, both individually and in any possible combination, be essential for implementing the invention in its various embodiments.

### LIST OF REFERENCE SIGNS

P Power

t Time

2; 3; 5; 10; 13 Decision step

1; 6; 7; 8; 9; 11; 12 Method step

21 Device for providing control power

22 Energy store

23 Control system

24 Electricity network

25 Device for determining the frequency deviation

1-20. (canceled)

21. A method for providing control power for an electricity network in which at least one energy store connected to the electricity network supplies energy to the electricity network as required and/or takes up energy from the electricity network as required, wherein,
when there is a change of a required control power, a time after the change from which a changed control power is provided by the energy store is chosen in dependence on a charging state at a given time of the energy store.

22. A method according to claim 21, wherein
a change of the required control power is established by a change of a frequency deviation of a network frequency of the electricity network from a setpoint value of the network frequency of the electricity network being measured, or a change of the frequency deviation by a minimum amount, or by 10 MHz, an amount of the control power depending on a level of the frequency deviation, or being chosen in certain regions in linear proportion to a level of the frequency deviation.

23. A method according to claim 21, wherein
the frequency deviation is measured with a greater accuracy than is necessary for delivering the control power, or with an accuracy of at least ±8 MHz, or at least ±4 MHz, or at least ±2 MHz, or at least ±1 MHz.

24. A method according to claim 21, wherein
the given time lies in a time interval between a change of required control power and a maximum time after the change, or the time interval depending on a type of control power requested, or the time interval being 30 seconds in a case of a provision of primary control power, 5 minutes in a case of a provision of secondary control power, and 15 minutes in a case of a provision of minutes reserve power.

25. A method according to claim 21, wherein
the charging state of the energy store is adapted by choosing the given time, or a desired medium energy content in the energy store is aimed for, the desired medium energy content lying in a range between 20% and 80% of maximum energy content in the energy store, or between 40% and 60%, or at 50% of the maximum energy content in the energy store.

26. A method according to claim 21, wherein,
when there is a change of the required control power, positive control power is fed into the electricity network at an early time, or immediately, and/or negative control power is removed from the electricity network at a late time, or at a latest possible time, if the charging state of the energy store lies above a first limit value and/or, when there is a change of the required control power, negative control power is removed from the electricity network at an early time, or immediately, and/or positive control power is fed into the electricity network at a late time, or at a latest possible time, if the charging state of the energy store lies below a second limit value, the two limit values defining a desired medium charging state.

27. A method according to claim 21, wherein
a flywheel, a heat store, a hydrogen generator and store with a fuel cell, a natural gas generator with a gas-fired power plant, a pumped storage power plant, a compressed-air storage power plant, a superconducting magnetic energy store, a redox-flow element and/or a galvanic element, a rechargeable battery, and/or a battery storage power plant, is used as the energy store.

28. A method according to claim 27, wherein
a lithium-ion battery, a lead-sulphuric acid battery, a nickel-cadmium battery, a sodium-sulphide battery, and/or a Li-ion battery, and/or a composite of at least two of these rechargeable batteries is used as the energy store.

29. A method according to claim 21, wherein
the energy store has a capacity of at least 1 kWh, or at least 10 kWh, or at least 50 kWh, or at least 250 kWh.

30. A method according to claim 21, wherein
the energy store is operated jointly with at least one energy generator and/or at least one energy consuming entity for a provision of control power for the electricity network.

31. A method according to claim 30, wherein
the energy store is operated in a closed-loop control and/or open-loop control in dependence on and in operative connection with the at least one energy generator and/or with the at least one energy consuming entity in a provision of control power for an electricity network.

32. A method according to claim 21, wherein
a tolerance with respect to a frequency deviation from a setpoint value of the network frequency of the electricity network is used to set the charging state of the energy store at a same time as providing the control power by the energy store.

33. A method according to claim 21, wherein
a tolerance with respect to an amount of the control power provided is used to set the charging state of the energy store at a same time as providing the control power by the energy store, or an amount of the requested control power being exceeded, or by a maximum of 30% and/or by 10 MW, or by a maximum of 20% and/or by 5 MW, to make use of the tolerance with respect to the amount of the control power provided, or a percentage by which the amount of the requested control power is exceeded being chosen in proportion to a deviation of the charging state of the energy store from a desired medium charging state.

34. A method according to claim 32, wherein
the charging state of the energy store is set by the energy store feeding into the electricity network a greater control power, lying within the tolerance, or taking up from the electricity network a smaller control power, lying within the tolerance, in a case that the charging state of the energy store lies above a first limit value, and/or the energy store feeding into the electricity network a smaller control power, lying within the tolerance, or taking up from the electricity network a greater control power, lying within the tolerance, in a case that the charging state of the energy store lies below a second limit value.

35. A method according to claim 21, wherein
a control power gradient is chosen in dependence on the charging state of the energy store, a variation over time of the amount of the control power being set and a tolerance of an amount of the control power to be provided over time being used.

36. A method according to claim 21, wherein,
when there is a change of the frequency deviation by less than a range of insensitivity, or by less than 10 MHz, a changed control power can only be delivered to set the charging state of the energy store, or the changed control power can only be delivered if the charging state of the energy store is thereby charged or discharged as strongly as possible towards the medium charging state or as little as possible away from the medium charging state.

37. A device for carrying out a method according to claim 21, comprising at least one energy store and a control system for controlling the power of the energy store in an open-loop and/or closed-loop manner, the energy store being connected to an electricity network such that energy can be fed into the electricity network and can be removed from the electricity network by the device.

38. A device according to claim 37, wherein
the device further comprises at least one energy generator and/or at least one energy consuming entity that is connected to the electricity network such that control power can be fed into the electricity network by the energy generator and/or can be removed from the electricity network by the energy consuming entity, or the energy store can be charged by the energy generator and/or discharged by the energy consuming entity.

39. A device according to claim 37, wherein
the device further comprises a device for measuring the charging state of the at least one energy store and a data memory, the desired medium charging state of the energy store being stored in the data memory, the control system having access to the data memory and being configured to control the control power delivered and/or taken up by the energy store in dependence on the charging state of the energy store.

40. A device according to claim 37, wherein
the energy store is a rechargeable battery, a lithium-ion battery, a lead-sulphuric acid battery, a nickel-cadmium battery, a sodium-sulphide battery, and/or a Li-ion battery, and/or a composite of at least two of these rechargeable batteries.
